(19) United States
(12) Patent Application Publication
(10) Pub. No.: US 2021/0149030 A1
(43) Pub. Date: May 20, 2021

(54) LASER SCANNER WITH CALIBRATION FUNCTIONALITY

(71) Applicant: LEICA GEOSYSTEMS AG, Heerbrugg (CH)

(72) Inventors: Christian NIKLAUS, Bad Ragaz (CH); Christoph HERBST, Dornbirn (AT)

(73) Assignee: LEICA GEOSYSTEMS AG, Heerbrugg (CH)

(21) Appl. No.: 16/951,949

(22) Filed: Nov. 18, 2020

(30) Foreign Application Priority Data
Nov. 19, 2019 (EP) 19210183.0

(51) Int. Cl. G01S 7/497; G01S 17/42; G01S 7/481

(52) U.S. Cl. CPC G01S 7/497; G01S 17/42; G01S 7/4817; G01S 7/4812; G01S 7/4813

(57) ABSTRACT

A laser scanner comprising a base, a body, a first motor for rotating the body relative to the base at a first speed, a first angle encoder determining a first angle of the body, an emitter emitting a transmission beam, a receiver detecting a reception beam, a deflector deflecting the transmission beam towards a setting, deflecting the reception beam to the receiver, a second motor rotating at a second speed higher than the first speed, a second angle encoder determining a second angle of the deflector, a processor determining a distance based on the emitted transmission beam and the detected reception beam, determining a point based on the first angle, the second angle, and the determined distance. The processor determines first calibration points and second calibration points, a first deviation based on the first calibration points the second calibration points, and based on the first deviation, determining first calibration parameters.

### CROSS-REFERENCE TO RELATED APPLICATIONS

This application claims priority to European Patent Application No. 19210183.0, filed on Nov. 19, 2019. The foregoing patent application are incorporated herein by reference.

### FIELD OF THE INVENTION

The present invention relates to a laser scanner with a calibration functionality.

### BACKGROUND OF THE INVENTION

Laser scanning is used to survey many different settings such as construction sites, historical buildings, industrial facilities or any other applicable setting. The laser scans achieved therewith may be used to obtain accurate three-dimensional (3D) models of a setting, wherein the models consist of a cloud of points.

Common laser scanners comprise a unit for sending out and receiving the reflected light signals in order to measure the distance of a point the signal was directed at. Usually, these scanners furthermore comprise means to rotatably alter the direction of the signals, commonly a vertical rotation axis and a horizontal rotation axis, of which one may be a slow axis and the other one may be a fast axis, wherein both axes are sensed with angle sensors.

The points of the point cloud may be achieved with distance values and solid angles, wherein the laser scanner defines the origin. The distances may be calculated with the travel time measurement method by observing the time between sending out and receiving a signal. The solid angles are obtained with said angle sensors tracking respective rotations around the vertical axis and around the horizontal axis.

### OBJECT OF THE INVENTION

Some aspects of the invention provide an improved laser scanner with a calibration functionality. In particular, the calibration functionality according to the invention allows for a simpler, more accurate, more intuitive, and more ergonomic calibration process.

### SUMMARY OF THE INVENTION

Some aspects of the invention relate to a laser scanner comprising a base, a body mounted on the base, a first motor configured for rotating the body relative to the base around an azimuth axis with a first speed, a first angle encoder configured for determining a first angle of the body with respect to the azimuth axis, an emitter configured for emitting a transmission beam, a receiver configured for detecting a reception beam, a deflector mounted in the body and configured for deflecting the transmission beam from the emitter towards a setting, deflecting the reception beam from the setting to the receiver, a second motor configured for rotating the deflector relative to the body around an elevation axis with a second speed, the second speed being higher than the first speed, a second angle encoder configured for determining a second angle of the deflector with respect to the elevation axis, a processor configured for determining a distance based on the emitted transmission beam and the detected reception beam, determining a point based on the first angle, the second angle, and the determined distance, wherein the processor is further configured for determining a plurality of first calibration points of a first calibration area of the setting in a first face, determining a plurality of second calibration points of the first calibration area in a second face, determining a first deviation between at least part of the first calibration area as determined with the first calibration points and at least part of the first calibration area as determined with the second calibration points, and based on the first deviation, determining first calibration parameters, wherein determining the point is further based on the first calibration parameters.

Determining the first deviation may be based on an offset between a first surface and a second surface, wherein the first surface is based on the first calibration points and the second surface is based on the second calibration points.

The first surface may run through at least some of the first calibration points.

The second surface may run through at least some of the second points.

The processor may be configured for fitting a first plane in at least part of the first calibration points, wherein the first surface is the first plane.

The processor may be configured for fitting a second plane in at least part of the second calibration points, wherein the second surface is the second plane.

The processor may be configured to determine an angle between the first plane and the second plane, wherein the calibrating is further based on the angle.

The first face may differ from the second face in a shift of 180° of an azimuthal alignment of the body.

The processor may further be configured for (a) determining, in particular with a full dome scan, a plurality of first discovery points of a discovery area of the setting in the first face, wherein the discovery area comprises the first calibration area, in particular wherein the first discovery points comprise the first calibration points, (b) determining at least a first calibration area candidate, and (c) generating or receiving a selection of at least the first calibration area out of the calibration area candidates.

Determining the at least one calibration area candidate may be based on an analysis of the discovery points.

The analysis of the discovery points may be based on (a) at least one distribution criterion of the distances and second angles of the respective discovery points located in the calibration area candidate, and/or (b) at least one fitting criterion which concerns a fitting of a plane in at least part of the respective discovery points located in the calibration area candidate.

The selection may be based on a weighting attributed to the calibration area candidate, wherein the processor is configured for determining the weighting based on at least one of: (a) how the respective discovery points located in the calibration area candidate quantitatively meet the at least one distribution criterion, (b) how the respective discovery points located in the calibration area candidate quantitatively meet the at least one fitting criterion, and (c) a measuring quality of the respective discovery points located in the calibration area candidate with respect to a reception beam quality and/or a reception beam intensity.

The processor may further be configured for determining, in particular with a full dome scan, a plurality of second discovery points of the discovery area of the setting in the second face, wherein the second discovery points comprise the second calibration points.

The processor may further be configured for (a) generating or receiving a selection of at least a second calibration area out of the calibration area candidates, (b) determining at least a second calibration area candidate, and (c) generating or receiving a selection of at least the second calibration area out of the calibration area candidates, (d) wherein first discovery points in the second calibration area are defined as third calibration points, (e) determining a plurality of fourth calibration points of the second calibration area in the second face, (f) determining a second deviation between (1) at least part of the second calibration area as determined with the third calibration points and (2) at least part of the second calibration area as determined with the fourth calibration points, and (g) based on the second deviation, determining second calibration parameters, wherein determining the point is further based on the second calibration parameters.

Some aspects of the invention also relate to an automatic calibration method for a laser scanner according to the above description, the method comprising the steps of the laser scanner (a) determining a plurality of calibration points by performing a full dome scan while azimuthally turning the body (in particular by more than 180°, specifically by at least 190°, preferably by at least 200°) such that there is at least one overlapping area in which calibration points determined in a first face overlap (in particular by more than 0°, specifically by at least 10°, preferably by at least 20°) with calibration points determined in a second face, (b) fitting a first plane in at least part of the calibration points in the overlapping area as determined in the first face, (c) fitting a second plane in at least part of the calibration points in the overlapping area as determined in the first face, wherein the first plane and the second plane overlap at least in part from the perspective of the laser scanner, (d) determining a deviation represented by at least one of a distance between the first and second plane and an angle between the first and second plane, (e) based on the deviation, determining calibration parameters, (f) determining measuring points while taking into account the calibration parameters.

### BRIEF DESCRIPTION OF THE DRAWINGS

By way of example only, preferred embodiments of the invention will be described more fully hereinafter with reference to the accompanying figures, wherein:

FIG. 1 shows an embodiment of a laser scanner obtaining a 3D point cloud of a room;

FIG. 2 shows an embodiment of a laser scanner in a sectional view;

FIG. 3 shows a section of a scene recorded from two different faces;

FIG. 4 shows a calibration area;

FIGS. 5 and 6 show two angles □ and □ that characterise how the two planes from FIG. 4 are inclined relative to each other;

FIG. 7 shows a full dome scan with visualised weightings of the scan points; and

FIG. 8 shows several criteria that can be taken into account when generating the weightings to be assigned to the points.

### DETAILED DESCRIPTION OF THE DRAWINGS

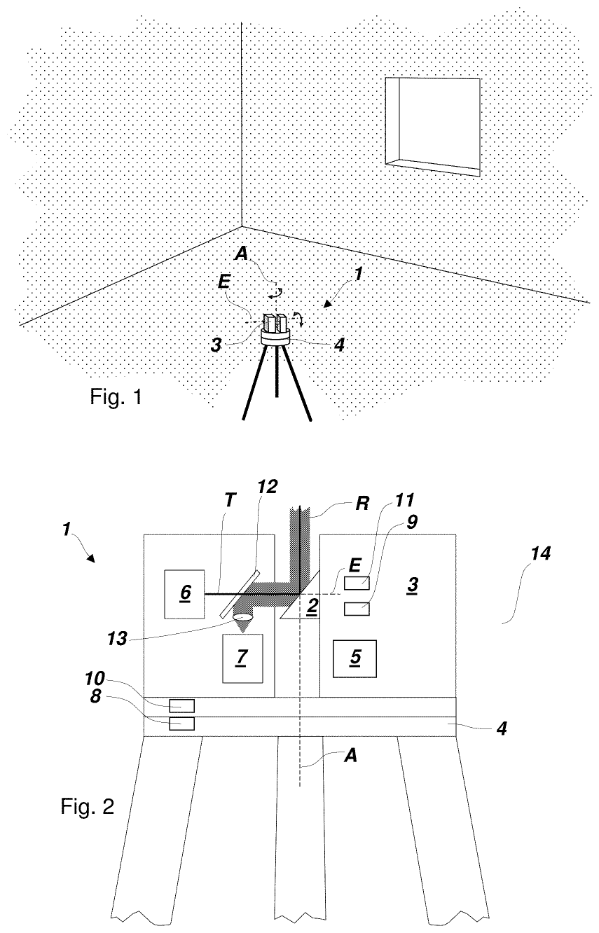

FIG. 1 shows a typical indoor measuring situation with a laser scanner 1 placed on a tripod. The laser scanner 1 is shown in FIG. 2 in greater detail. Such laser scanners are designed to generate a relatively dense 3D point cloud of a scene in a relatively short time. The points are determined in polar coordinates in that a first angle is measured of the current azimuthal rotation, a second angle is measured of the current elevative rotation, and a distance is measured in the current alignment. This is done thousands of times per second, in some cases up to millions of times per second, while the azimuth is changed relatively slowly and the elevation is changed relatively fast. The slow axis is tagged with A for azimuth in FIG. 1, and the fast axis is tagged with E for elevation.

As indicated by the arrows, the laser scanner 1 is scanning the scene by deflecting a measuring beam with a deflector 2 out of and back into the scanner (it is sent by the emitter 6 towards the scene as a transmission beam T, the reflection of which is received by the receiver 7 as reception beam R by the scanner) while rotating the deflector 2 around the horizontal elevation axis E, and while rotating a body 3 of the laser scanner around the vertical azimuth axis A relative to the base 4. The body 3 is rotated by a first motor 10, and the deflector 2 is rotated by a second motor 11.

A processor 5 is provided to determine the distances by EDM (electronic distance measurement) techniques known from prior art, such as the time of flight (TOF) method. The processor 5 is further provided to receive the angle information from the first angle encoder 8 that determines the first angle with respect to the azimuth axis A, and from the second angle encoder 9 that determines the second angle with respect to the elevation axis E.

The configuration as shown in FIG. 2 is an example. The emitter 6 is positioned to direct the transmission beam T through a semi-transparent mirror 12 towards the deflector 2. The receiver 7 is positioned to receive the reception beam R that has been first deflected by the deflector 2, then deflected by the semi-transparent mirror 12, and then collimated by the collimator 13.

One reason that the laser scanner has to be calibrated once in a while is the emergence of geometry errors in the azimuth axis and elevation axis after some time due to wear or inappropriate handling (shocks, etc.). Other reasons may originate from mounting errors of the emitter 6, receiver 7, optical elements (such as the semi-transparent mirror 12 or the collimator 13), the deflector 2, the first angle encoder 8, and/or the second angle encoder 9. By means of calibration parameters that are applied to the intrinsic geometry of the laser scanner, such geometry errors can be compensated according to the invention.

Once the body 3 made a turn of more than 180° the laser scanner begins to measure the same points again but from another face. Because of the geometry errors, the points measured in a first face deviate from points measured in a second face. This fact is used by the present invention.

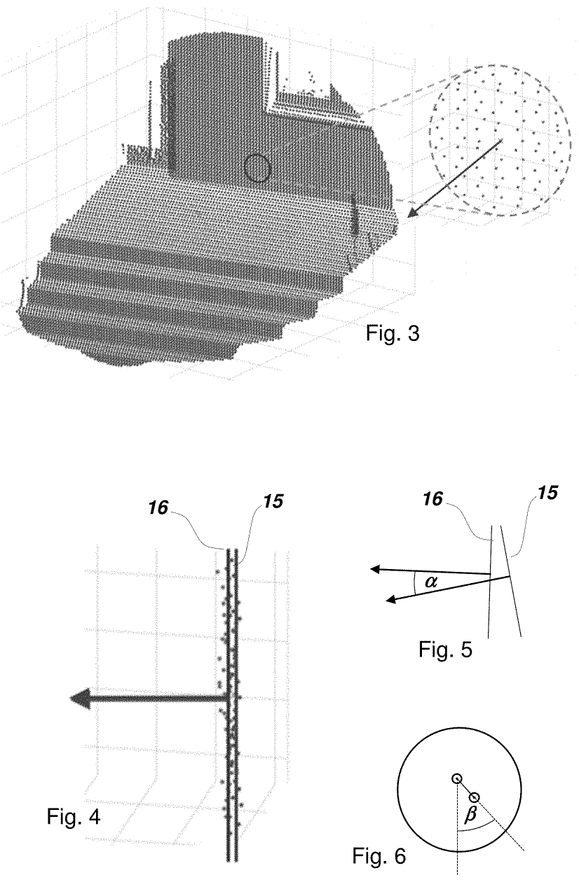

FIG. 3 shows a section of a scene recorded from two different faces. This section is the calibration area 14. The two point clouds, i.e. the first calibration points and the second calibration points, cannot be distinguished in this view of the figure, however, FIG. 4 shows the calibration area 14 which is circled and enlarged in FIG. 3 from the side, i.e. parallel to the wall, wherein a plane is fitted into each of the point clouds which clearly shows the deviation between the two point clouds.

In the shown example, the first plane 15 and the second plane 16 are used by the processor 5 for determining a deviation between the calibration area as determined with the first calibration points (first face) and the calibration area 14 as determined with the second calibration points (second face). A deviation in this example comprises a distance between the planes 15 and 16 and two angles that characterise how the two planes are inclined relative to each other. These two angles α and β are shown in abstracted and exaggerated views (frontal and lateral) of the two planes in FIGS. 5 and 6.

The distance between the two planes can be determined in different alternative ways. A centre of the calibration area could be used to measure a normal distance. In other embodiments, the distance between the planes could be averaged. In yet further embodiments, a maximum distance throughout the area could be determined, which e.g. would be in FIG. 5 the distance between of the planes 15 and 16 at their lower ends.

Based on this deviation, the calibration parameters are determined, wherein the calibration parameters are from then on taken into account when determining a new point (cloud) with the laser scanner. This calibration can be done in the field without the need for shipping the scanner to after sales service. In particular, the calibration can be performed automatically upon request of the user, or upon a scheduled triggering. In some embodiments, the calibration can be manually or automatically repeated at least one time in order to further increase the precision resulting from the calibration(s).

In a particular embodiment, more than just one calibration area can be taken into account. Thus, the determination of calibration parameters can either be based on deviations of these calibration areas at once, or the calibration parameters may be determined for the deviations sequentially. In particular, considering calibration areas with different elevation ranges increases the quality of the calibration. The further the calibration areas are apart from each other with respect to elevation, the better is the quality of the calibration.

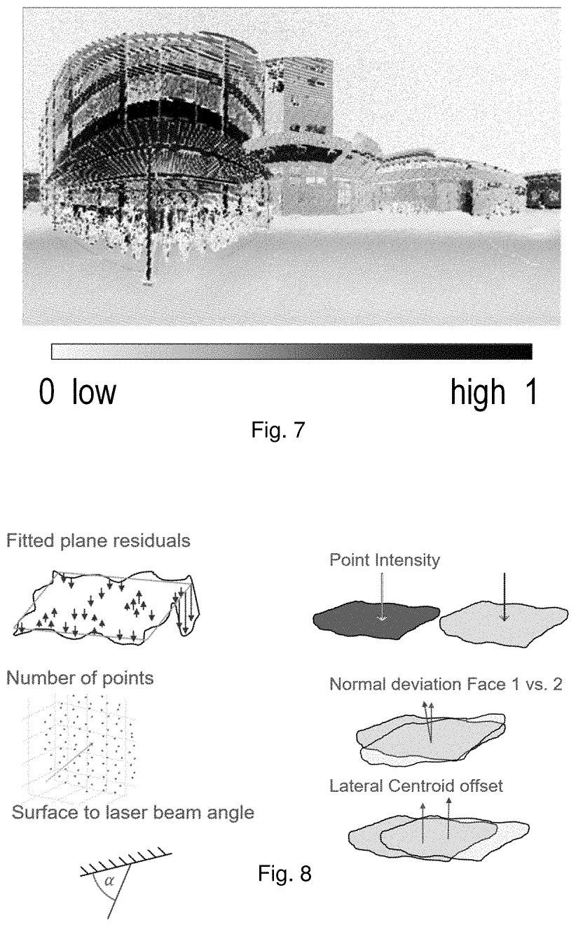

FIG. 7 shows a full dome scan made with the laser scanner containing evaluations of the respective points with regard to their suitability for being used for the calibration. The point cloud is hence analysed and the points assigned to a value between 0 (low suitability) and 1 (high suitability). For illustrative purposes, the points more suitable for the calibration are darker in the figure and the lesser suitable points are brighter. In particular, for the calibration, a smoothest possible surface is preferred, specifically a smooth surface that is facing the laser scanner in a 45° inclination angle.

In particular, this full dome scan is obtained in a first face and by determining a plurality of first discovery points of this discovery area of the setting. In FIG. 7 the discovery area is the full setting, but in other embodiments the discovery area can only be a section of the setting. From the discovery area the processor then determines at least a first calibration area candidate, in particular a plurality of candidates. The processor can then automatically generate a selection or receive a selection made by a user of one of the candidate(s) to be used as calibration area. If there are several candidates selected, then there can also be more than one calibration area to be used for the calibration.

The full dome scan of FIG. 7 is optional—the above explained process does not necessarily require such a wide area and will also work with smaller areas. The discovery area can also comprise two or more sections of the setting, e.g. four setting windows apart from each other by 90° azimuth.

At least part of the relevant discovery area is then scanned again in the second face, providing second discovery points, i.e. the discovery area is scanned with a support turned by 180°. The processor could either direct the laser scanner to scan the whole discovery area again, or only those parts containing the selected calibration area candidate(s).

The black-and-white evaluation that has been shown with FIG. 7 does particularly depend on one or more criteria. The evaluation can be seen as “weightage”, i.e. the points are assigned to weightings as a result of assessing their suitability of being used for a calibration. Some of those criteria are discussed with FIG. 8 as follows:

The weighting may depend on how well a plane can be fitted in the candidate area, i.e. the weighting is a measure for the flatness of the points in the candidate area are aligned and/or to what extend there are residuals (fitting criterion).

A further criterion is the amount of points, wherein of course a higher amount is desirable. The more points there are in the neighbourhood, the higher is the weighting of a point. In particular, only considering the amount of points further fulfilling any other certain criterion has also effect on this amount criterion.

The inclination between the surface and the laser beam impinging on the surface can be determined. At an inclination of 45°, the weighting of the points laying on the respective surface may reach a maximum and the more the angle departs from this optimum angle, the lower the weighting may be.

According to a measuring quality criterion, points that are determined with a high intensity return pulse(=high reflectivity of the surface) are preferred such that they get a higher weighting. It also or alternatively may comprise a reception beam quality.

The last two examples require the second scan in the second face in order to produce weightings. Independent of the calibration, the normal deviation between the plane as detected in the first face and the plane as detected in the second face can be taken into account when determining the weightings. Having a relatively high deviation means that this area would have a high impact on the calibration, so that the points in this area can be assigned high weightings. The same is true for lateral offsets of areas detected in the two faces. The lateral deviation can e.g. be determined with help of a feature recognition algorithm.

Not being shown in the figures, the distribution criterion as mentioned in this application is usable to describe the distribution of the discovery points with respect to their distances to the scanner and to their second angles (elevation angles). A smooth distribution of the distance values and a smooth distribution of elevation angles is a direct indicator for smooth surfaces which let the respective points earn a high weighting because they are very suitable candidates for the calibration.

All above mentioned criteria for assigning a weighting to the points can be combined in any constellation.

Although the invention is illustrated above, partly with reference to some preferred embodiments, it must be understood that numerous modifications and combinations of different features of the embodiments can be made. All of these modifications lie within the scope of the appended claims.

What is claimed is:

1. A laser scanner comprising:
a base;
a body mounted on the base;
a first motor configured for rotating the body relative to the base around an azimuth axis with a first speed;
a first angle encoder configured for determining a first angle of the body with respect to the azimuth axis;
an emitter configured for emitting a transmission beam;
a receiver configured for detecting a reception beam;
a deflector mounted in the body and configured for:
deflecting the transmission beam from the emitter towards a setting, and
deflecting the reception beam from the setting to the receiver;
a second motor configured for rotating the deflector relative to the body around an elevation axis with a second speed, the second speed being higher than the first speed;
a second angle encoder configured for determining a second angle of the deflector with respect to the elevation axis; and
a processor configured for:
determining a distance based on the emitted transmission beam and the detected reception beam, and
determining a point based on the first angle, the second angle, and the determined distance,
wherein the processor is further configured for:
determining a plurality of first calibration points of a first calibration area of the setting in a first face,
determining a plurality of second calibration points of the first calibration area in a second face,
determining a first deviation between:
at least part of the first calibration area as determined with the first calibration points, and
at least part of the first calibration area as determined with the second calibration points, and
based on the first deviation, determining first calibration parameters, wherein determining the point is further based on the first calibration parameters.

2. The laser scanner according to claim 1, wherein determining the first deviation is based on an offset between a first surface and a second surface, wherein the first surface is based on the first calibration points and the second surface is based on the second calibration points.

3. The laser scanner according to claim 2, wherein the first surface runs through at least some of the first calibration points.

4. The laser scanner according to claim 2, wherein the second surface runs through at least some of the second points.

5. The laser scanner according to claim 2, wherein the processor is configured for fitting a first plane in at least part of the first calibration points, wherein the first surface is the first plane.

6. The laser scanner according to claim 2, wherein the processor is configured for fitting a second plane in at least part of the second calibration points, wherein the second surface is the second plane.

7. The laser scanner according to claim 5, wherein the processor is configured to determine an angle between the first plane and the second plane, wherein the calibrating is further based on the angle.

8. The laser scanner according to claim 1, wherein the first face differs from the second face in a shift of 180° of an azimuthal alignment of the body.

9. The laser scanner according to claim 4, wherein the processor is configured for fitting a second plane in at least part of the second calibration points, wherein the second surface is the second plane.

10. The laser scanner according to claim 1, wherein the processor is further configured for:
determining a plurality of first discovery points of a discovery area of the setting in the first face, wherein the discovery area comprises the first calibration area,
determining at least a first calibration area candidate, and
generating or receiving a selection of at least the first calibration area out of the calibration area candidates.

11. The laser scanner according to claim 10, wherein determining the at least one calibration area candidate is based on an analysis of the discovery points.

12. The laser scanner according to claim 11, wherein the analysis of the discovery points is based on:
at least one distribution criterion of the distances and second angles of the respective discovery points located in the calibration area candidate, or
at least one fitting criterion which concerns a fitting of a plane in at least part of the respective discovery points located in the calibration area candidate.

13. The laser scanner according to claim 12, wherein the selection is based on a weighting attributed to the calibration area candidate, wherein the processor is configured for determining the weighting based on at least one of:
how the respective discovery points located in the calibration area candidate quantitatively meet the at least one distribution criterion,
how the respective discovery points located in the calibration area candidate quantitatively meet the at least one fitting criterion, and
a measuring quality of the respective discovery points located in the calibration area candidate with respect to a reception beam quality or a reception beam intensity.

14. The laser scanner according to claim 10, wherein the processor is further configured for:
determining a plurality of second discovery points of the discovery area of the setting in the second face, wherein the second discovery points comprise the second calibration points.

15. The laser scanner according to claim 10, wherein the processor is further configured for:
generating or receiving a selection of at least a second calibration area out of the calibration area candidates,
determining at least a second calibration area candidate, and
generating or receiving a selection of at least the second calibration area out of the calibration area candidates,
defining first discovery points in the second calibration area as third calibration points,
determining a plurality of fourth calibration points of the second calibration area in the second face,
determining a second deviation between:
at least part of the second calibration area as determined with the third calibration points and
at least part of the second calibration area as determined with the fourth calibration points, and
based on the second deviation, determining second calibration parameters, wherein determining the point is further based on the second calibration parameters.

16. An automatic calibration method for a laser scanner, the method comprising:
determining a plurality of calibration points by performing a full dome scan while azimuthally turning the body such that there is at least one overlapping area in which calibration points determined in a first face overlap with calibration points determined in a second face,
fitting a first plane in at least part of the calibration points in the overlapping area as determined in the first face;
fitting a second plane in at least part of the calibration points in the overlapping area as determined in the first face, wherein the first plane and the second plane overlap at least in part from the perspective of the laser scanner;
determining a deviation represented by at least one of a distance between the first and second plane and an angle between the first and second plane;
based on the deviation, determining calibration parameters; and
determining measuring points while taking into account the calibration parameters.
